(19) United States
(12) Patent Application Publication
(10) Pub. No.: US 2019/0246424 A1
(43) Pub. Date: Aug. 8, 2019

(54) Information Transmission Apparatus and Method and Communication System

(71) Applicant: FUJITSU LIMITED, Kawasaki-shi (JP)

(72) Inventors: Jian ZHANG, Beijing (CN); Wei XI, Beijing (CN); Xin WANG, Beijing (CN); Hua ZHOU, Beijing (CN)

(73) Assignee: FUJITSU LIMITED, Kawasaki-shi (JP)

(21) Appl. No.: 16/384,259

(22) Filed: Apr. 15, 2019

Related U.S. Application Data
(63) Continuation of application No. PCT/CN2016/104437, filed on Nov. 3, 2016.

(51) Int. Cl. H04W 74/08; H04L 1/18; H04L 27/26

(52) U.S. Cl. CPC H04W 74/08; H04L 27/2649; H04L 1/1812

(57) ABSTRACT

An information transmission apparatus and method and communication system. The information transmission method includes: receiving transmission information containing data, which is transmitted by a transmitting device in a grant-free manner; identification information of the transmitting device is explicitly or implicitly carried in the transmission information; demodulating and checking the transmission information, and determining whether the identification information of the transmitting device and the data contained in the transmission information are correctly obtained; and feeding control information containing ACK/NACK back to the transmitting device, by using the identification information of the transmitting device or using sequence information of a DM-RS that is used for demodulating the transmission information.

### CROSS-REFERENCE TO RELATED APPLICATIONS

This application is a continuation application of International Application PCT/CN2016/104437 filed on Nov. 3, 2016 and designated the U.S., the entire contents of which are incorporated herein by reference.

### TECHNICAL FIELD

This disclosure relates to the field of communication technologies, and in particular to an information transmission apparatus and method and a communication system.

### BACKGROUND

In a conventional long-term evolution (LTE) system, uplink data transmission of a user equipment needs to be scheduled by a base station. The advantage is that the base station is able to schedule data of different user equipments onto mutually orthogonal time-frequency resources, thereby completely avoiding collisions between user equipments and interference resulted therefrom.

For the scheduled transmission, a connection needs to be established with the base station before the user equipment initiates actual data transmission.

FIG. 1 is a schematic diagram of scheduling transmission. As shown in FIG. 1, a user equipment initiates a scheduling request (SR) to a base station, then the base station transmits an uplink scheduling signaling (UL grant) to the user equipment, and finally the user equipment performs uplink data transmission according to the scheduling signaling. That is, there exists a signaling exchange overhead between the user equipment and the base station before the actual data transmission, which is acceptable for user equipments having a large amount of data transmission.

However, with increasing varieties of terminal types and corresponding services, such as massive machine-type communication (mMTC) and ultra-reliable and low-latency communication (URLLC) demands that the fifth-generation (5G) system needs to meet, high throughput is no longer the only design goal, an mMTC user equipment may be engaged mainly in bursty services, and use small packet transmission. If the LTE-similar signaling exchange is still carried out step by step before the small packet data transmission, it is likely that the signaling overhead occupies the majority of the data transmission, thereby reducing the transmission efficiency. In another perspective, a connection establishment procedure before the data transmission also brings about an increase in delay, which is an adverse factor in achieving low latency needed by the URLLC.

Therefore, grant-free transmission has received more and more attention and research as a new data channel transmission mode.

FIG. 2 is a schematic diagram of grant-free transmission, showing the main concept of grant-free transmission. When data arrive at the user equipment, the user equipment may initiate data transmission immediately without waiting for a scheduling from the base station, thereby reducing signaling and delay overhead required for the user equipment to establish connection with the base station. For the grant-free transmission, since there is no base station involved in scheduling, physical resource collision between user equipments is often difficult to be avoided, but with a non-orthogonal technology and the use of advanced multi-user receivers, successful demodulation of data of collided user equipments may still be achieved under certain conditions.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that in performing grant-free transmission, if a receiving device is unable to correctly obtain data transmitted by a transmitting device, it is unable to obtain identification information of the transmitting device. Hence, non-acknowledgement (NACK) information is unable to be fed back to the transmitting device, and high-efficiency data retransmission is unable to be achieved in grant-free transmission.

Embodiments of this disclosure provide an information transmission apparatus and method and a communication system. In performing grant-free transmission, even though a receiving device is unable to correctly obtain data transmitted by a transmitting device, it may feed back NACK information to the transmitting device based on identification information of the transmitting device or sequence information of a demodulation reference signal, and high-efficiency data retransmission may be achieved in grant-free transmission.

According to a first aspect of the embodiments of this disclosure, there is provided an information transmission method, applicable to a receiving device, the information transmission method including:

receiving transmission information containing data, which is transmitted by a transmitting device in a grant-free manner; identification information of the transmitting device is explicitly or implicitly carried in the transmission information;

demodulating and checking the transmission information, and determining whether the identification information of the transmitting device and the data contained in the transmission information are correctly obtained; and

feeding control information containing acknowledgment or non-acknowledgment back to the transmitting device, by using the identification information of the transmitting device or using sequence information of a demodulation reference signal that is used for demodulating the transmission information.

According to a second aspect of the embodiments of this disclosure, there is provided an information transmission apparatus, configured in a receiving device, the information transmission apparatus including:

a data receiving unit configured to receive transmission information containing data, which is transmitted by a transmitting device in a grant-free manner; identification information of the transmitting device is explicitly or implicitly carried in the transmission information;

a data acquiring unit configured to demodulate and check the transmission information, and determine whether the identification information of the transmitting device and the data contained in the transmission information are correctly obtained; and

an information feedback unit configured to feed control information containing acknowledgment or non-acknowledgment back to the transmitting device, by using the identification information of the transmitting device or using sequence information of a demodulation reference signal that is used for demodulating the transmission information.

According to a third aspect of the embodiments of this disclosure, there is provided an information transmission method, applicable to a transmitting device, the information transmission method including:

transmitting transmission information containing data in a grant-free manner to a receiving device; identification information of the transmitting device is explicitly or implicitly carried in the transmission information; and

receiving control information containing acknowledgment or non-acknowledgment, which is fed back by the receiving device by using the identification information of the transmitting device or using sequence information of a demodulation reference signal that is used for demodulating the transmission information.

According to a fourth aspect of the embodiments of this disclosure, there is provided an information transmission apparatus, configured in a transmitting device, the information transmission apparatus including:

a data transmitting unit configured to transmit transmission information containing data in a grant-free manner to a receiving device; identification information of the transmitting device is explicitly or implicitly carried in the transmission information; and

an information receiving unit configured to receive control information containing acknowledgment or non-acknowledgment, which is fed back by the receiving device by using the identification information of the transmitting device or using sequence information of a demodulation reference signal that is used for demodulating the transmission information.

According to a fifth aspect of the embodiments of this disclosure, there is provided a communication system, including:

a transmitting device including the information transmission apparatus as described in the fourth aspect; and

a receiving device including the information transmission apparatus as described in the second aspect.

An advantage of the embodiments of this disclosure exists in that the identification information of the transmitting device is explicitly or implicitly carried in the transmission information, and the identification information of the transmitting device or sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in grant-free transmission.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of scheduling transmission;

FIG. 2 is a schematic diagram of grant-free transmission;

FIG. 3 is another schematic diagram of grant-free transmission;

FIG. 4 is a schematic diagram of the information transmission method of Embodiment 1 of this disclosure;

FIG. 5 is a schematic diagram of transmitting information of Embodiment 2 of this disclosure;

FIG. 6 is a schematic diagram of the information transmission method of Embodiment 2 of this disclosure;

FIG. 7 is a schematic diagram of collision occurred in retransmission in grant-free transmission;

FIG. 8 is a schematic diagram of retransmitting data by randomly selected resources;

FIG. 9 is an exemplary diagram of performing data retransmission of Embodiment 2 of this disclosure;

FIG. 10 is another exemplary diagram of performing data retransmission of Embodiment 2 of this disclosure;

FIG. 11 is a further exemplary diagram of performing data retransmission of Embodiment 2 of this disclosure;

FIG. 12 is yet another exemplary diagram of performing data retransmission of Embodiment 2 of this disclosure;

FIG. 13 is still another exemplary diagram of performing data retransmission of Embodiment 2 of this disclosure;

FIG. 14 is a schematic diagram of transmitting information of Embodiment 3 of this disclosure;

FIG. 15 is a schematic diagram of transmitting information of Embodiment 4 of this disclosure;

FIG. 16 is a schematic diagram of transmitting information of Embodiment 5 of this disclosure;

FIG. 17 is an exemplary diagram of performing data retransmission of Embodiment 7 of this disclosure;

FIG. 18 is a schematic diagram of the information transmission method of Embodiment 8 of this disclosure;

FIG. 19 is a schematic diagram of the information transmission apparatus of Embodiment 9 of this disclosure;

FIG. 20 is a schematic diagram of the information transmission apparatus of Embodiment 10 of this disclosure;

FIG. 21 is a schematic diagram of the communication system of Embodiment 11 of this disclosure;

FIG. 22 is a schematic diagram of the base station of Embodiment 11 of this disclosure; and

FIG. 23 is a schematic diagram of the user equipment of Embodiment 11 of this disclosure.

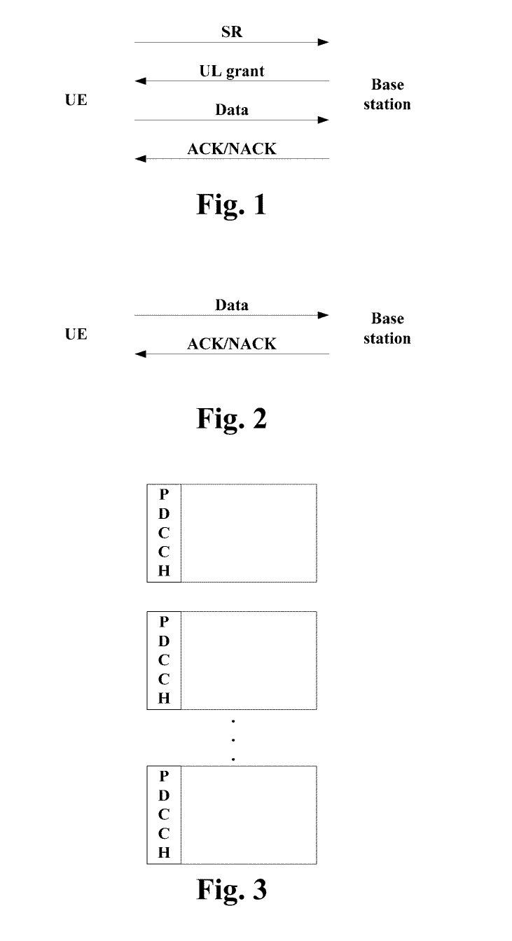

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In this disclosure, a base station may be referred to as an access point, a broadcast transmitter, a transmission/reception point (TRP), a node B, an evolved node B (eNB), or a remote radio head/unit (RRH/RRU), etc., and may include some or all functions thereof. A term “base station” shall be used in the text, and each base station provides communication coverage for a specific geographical region. A term “cell” may refer to a base station and/or its coverage region, depending on a context where the term is used.

In this disclosure, a mobile station or equipment may be referred to as a user equipment (UE). The UE may be fixed or mobile, and may also be referred to as a mobile station, a terminal, an access terminal, a user unit, or a station, etc. The UE may be a cellular phone, a personal digital assistant (PDA), a wireless modem, a wireless communication device, a handhold device, a machine-type communication device, a lap-top computer, and a cordless telephone, etc.

FIG. 3 is another schematic diagram of grant-free transmission. As shown in FIG. 3, a base station may reserve and configure multiple time-frequency resources for a grant-free user equipment. Grant-free transmission occurs within each time-frequency resource, and the user equipment may receive control signaling within each of the grant-free time-frequency resources, such as a physical downlink control channel (PDCCH), etc.

In this disclosure, each time-frequency resource used for grant-free transmission may be configured with a group of demodulation reference signal (DM-RS) sequences, and may further be configured with a group of spreading sequences/codewords/interleaving patterns. The DM-RS is used for equivalent channel estimation, and a coaction of the spreading sequences/codewords/interleaving patterns is to transform the data, in particular in different manners, such as spreading, constructing codewords, interleaving, etc.; or the data may be directly transmitted without any transform.

It is assumed that the total number of available DM-RS sequences is M, the total number of spreading sequences/codewords/interleaving patterns is N, and the total number of user equipments that may perform grant-free transmission is U. For a certain user u (u=1, 2, . . . , U), when grant-free transmission is performed, a certain spreading sequence/codeword/interleaving pattern n (n=1, 2, . . . , N) is used to transform data, then the data is transmitted, and a certain DM-RS sequence m (m=1, 2, . . . , M) is transmitted at the same time. For any one DM-RS sequence, a spreading sequence/codeword/interleaving pattern may be uniquely associated.

Which DM-RS sequence and associated spreading sequence/codeword/interleaving pattern are used by the user equipment may be randomly selected and determined according to the user equipment, or may be pre-configured by the base station.

In this disclosure, the base station may detect in a blind manner which user equipments have performed data transmission, that is, detecting activities of the user equipments in a blind manner. For example, if a certain DM-RS m is detected, the base station may perform channel estimation using the DM-RS, and deem that spreading sequence/codeword/interleaving pattern associated with the DM-RS is/are also received, and may perform data demodulation of the user equipments under this premise.

On the other hand, hybrid automatic repeat request (HARQ) is important means in ensuring reception performance, and the design of the grant-free transmission should be able to achieve compatibility with and support for HARQ retransmission.

For uplink grant-free transmission, retransmission may be roughly divided into two types. One is to retransmit original data, which means, bit information in retransmission is completely identical to that in initial transmission, such as a chase combining manner in HARQ. The other is to retransmit a redundancy version, and in this case, retransmitted bit information needs not to be identical to that in initial transmission, such as an incremental redundancy manner in the HARQ. There are problems needing to be solved in designs such as the introduction of the HARQ in the grant-free transmission, how the base station performs ACK/NACK notification and how to determine HARQ timing.

In this disclosure, design is performed on support for HARQ in grant-free transmission, and solutions for efficiently achieving HARQ functions in the grant-free transmission are provided. Following description shall be given by taking a base station in a communication system as a receiving device and a user equipment as a transmitting device as an example. However, this disclosure is not limited thereto; for example, the transmitting device and/or the receiving device may also be other network devices.

### Embodiment 1

These embodiments of this disclosure provide an information transmission method, applicable to a receiving device.

FIG. 4 is a schematic diagram of the information transmission method of the embodiment of this disclosure. As shown in FIG. 4, the information transmission method includes:

Block 401: transmission information containing data, which is transmitted by a transmitting device in a grant-free manner, is received; identification information of the transmitting device is explicitly or implicitly carried in the transmission information.

Block 402: the transmission information is demodulated and checked, and it is determined whether the identification information of the transmitting device and the data contained in the transmission information are correctly obtained; and

Block 403: control information containing acknowledgment (ACK) or non-acknowledgment (NACK) is fed back to the transmitting device, by using the identification information of the transmitting device or using sequence information of a demodulation reference signal that is used for demodulating the transmission information.

In an embodiment, the receiving device may be a macro base station (such as an eNB), and the transmitting device may be a user equipment; and the user equipment may be served by a macro cell generated by the macro base station. Or the receiving device may be a pico base station, and the transmitting device may be a user equipment or any device capable of receiving signals of the base station; and the user equipment may be served by a micro cell (such as a pico cell or a small cell) generated by the pico base station. Or, the receiving device and/or the transmitting device may be other network devices. However, this disclosure is not limited thereto, and a particular scenario may be determined according to an actual situation.

Following description shall be given by taking that a base station is a receiving device and a user equipment is a transmitting device as an example.

In an embodiment, a range of the DM-RS is pre-configured, and the user equipment may randomly select a DM-RS sequence. A sequence index of the DM-RS may be pseudo-randomly determined according to the identification information of the transmitting device; the DM-RS is determined according to the number of sequences and a user equipment correlation value, the user equipment correlation value changing along with a change of the number of times of transmission, and its initial value being the identification information of the transmitting device.

For example, for user equipment u, the DM-RS sequence may be selected by using the following formula:

mₖ=Xₖ mod M, where Xₖ₊₁=f(Xₖ);

where, mₖ is used to identify a DM-RS sequence selected in a k-th time of transmission, M denotes a total number of available DM-RSs; and a recursive function Xₖ₊₁=f(Xₖ) may be defined; where, f(.) denotes a certain transform function, for example, a function Xₖ₊₁=(A·Xₖ) mod D used for determining a PDCCH search space may be reused, (D=65537, A=39827), and k denotes the k-th time of transmission, k=0, 1, 2, . . . , K, X₀=UE ID, UE ID denoting identification of the user equipment.

UE ID is, for example, a cell radio network temporary identifier (C-RNTI), or a temporary mobile subscriber identity (TMSI), or an international mobile subscriber identity (IMSI), or an ID in other forms, with its function being to identify different user equipments.

In an embodiment, one or more of spreading sequences, code words, or interleaving patterns, may be determined according to the DM-RS, and the transmission information may be transformed according to the one or more of the spreading sequences, the code words, or the interleaving patterns.

Firstly, association between the DM-RS sequences and (one or more of) spreading sequences/code words/interleaving patterns may be established. After determining a DM-RS ID, the user equipment u may correspondingly determine the used spreading sequences/code words/interleaving patterns according to the association between the DM-RS sequences and spreading sequences/code words/interleaving patterns. For example,

nₖ=mₖ mod N;

where, N denotes the total number of available spreading sequences/code words/interleaving patterns. Usually, the number M of DM-RS sequences is larger than the number N of the spreading sequences/code words/interleaving patterns, i.e. M>N.

for example, assuming that N=4, M=8 and U=16, Table 1 below may be obtained by using the above method, in which examples of the correspondence between the DM-RS and the spreading sequences/code words/interleaving patterns and the user equipment are listed.

TABLE 1

| | Spreading sequences/code words/interleaving patterns | | | | | | | |
|---|---|---|---|---|---|---|---|---|
| | 1 | 2 | 3 | 4 | 1 | 2 | 3 | 4 |
| DM-RS | 1 | 2 | 3 | 4 | 5 | 6 | 7 | 8 |
| X values | 1 | 2 | 3 | 4 | 5 | 6 | 7 | 8 |
| | 9 | 10 | 11 | 12 | 13 | 14 | 15 | 16 |

It can be seen from Table 1 that it is possible for multiple user equipments to select the same DM-RS. Therefore, after detecting a certain DM-RS, the base station still needs to determine which user equipment the DM-RS belongs to, that is, determine the UE ID. The determination of the UE ID may be implemented by carrying the UE ID in the user equipment data, or may be determined in other methods, such as the method given in the following embodiments.

In an embodiment, the identification information of the transmitting device is carried in the transmission information explicitly or implicitly.

For example, the transmission information includes the data, identification information of the transmitting device, and a check code generated according to the data and the identification information; or the transmission information includes the data and a first check code generated according to the data, the identification information of the transmitting device and a second check code generated according to the identification information; or the transmission information includes the data and a check code generated according to the data, the check code is scrambled according to the identification information of the transmitting device; or the transmission information includes the data and a check code generated according to the data, a correspondence between the DM-RS and the identification information of the transmitting device is predetermined.

In an embodiment, control information containing ACK/NACK may be fed back to the transmitting device, by using the identification information of the transmitting device or using the sequence information of a DM-RS that is used for demodulating the transmission information.

For example, if the control information containing the ACK/NACK is carried in a physical downlink control channel (PDCCH), PDCCH check information (such as cyclic redundancy check, CRC) may be scrambled by using the identification information of the transmitting device or the sequence index of the DM-RS.

For another example, if the control information containing the ACK/NACK is carried in a physical hybrid automatic repeat request indicator channel (PHICH), a logical resource position of the PHICH may be determined by using the sequence index of the DM-RS or the identification information of the transmitting device.

In an embodiment, the receiving device may further receive retransmission data transmitted by the transmitting device; a resource transmitting the retransmission data is pseudo-randomly determined according to the sequence index of the DM-RS or the identification information of the transmitting device.

For example, the resource transmitting the retransmission data is determined according to the number of retransmission resources and a DM-RS correlation value, the DM-RS correlation value changing along with the change of the number of times of transmission, and its initial value being the sequence index of the demodulation reference signal for initially transmitting the transmission information.

For another example, the resource transmitting the retransmission data is determined according to the number of retransmission resources and a user equipment correlation value, the user equipment correlation value changing along with the number of times of transmission and an initial value thereof being the identification information of the transmitting device.

Hence, randomness may be brought to the selection of retransmission resources, and a probability of collision of retransmission data may be lowered.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 2

These embodiments of this disclosure provide an information transmission method, in which this disclosure is further described on the basis of Embodiment 1. However, these embodiments are not limited to the selection of a DM-RS in Embodiment 1, and are also applicable to a case where a user equipment randomly selects a DM-RS or a base station configures a DM-RS for a user equipment. In these embodiments, the transmission information includes the data, identification information of the transmitting device, and a check code generated according to the data and the identification information, with identical contents in Embodiment 1 being not going to be described herein any further.

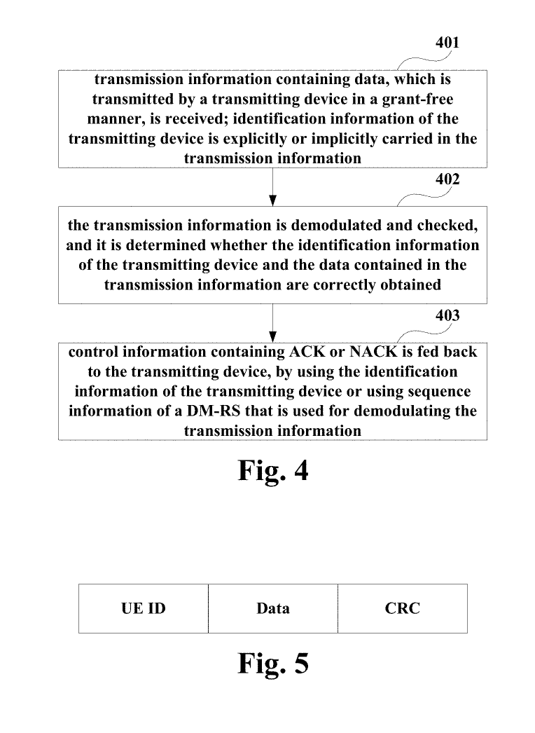

FIG. 5 is a schematic diagram of information transmission of the embodiment of this disclosure. As shown in FIG. 5, the UE ID is taken as a part of payload of the data and transmitted by the user equipment to the base station, and a CRC is generated jointly according to the UE ID and the data. If checking of the CRC is correct, the base station deems that the UE ID and the data are both correctly received. And if the base station discovers that the checking of the CRC is incorrect, it shows that an error occurs in the UE ID and/or the data.

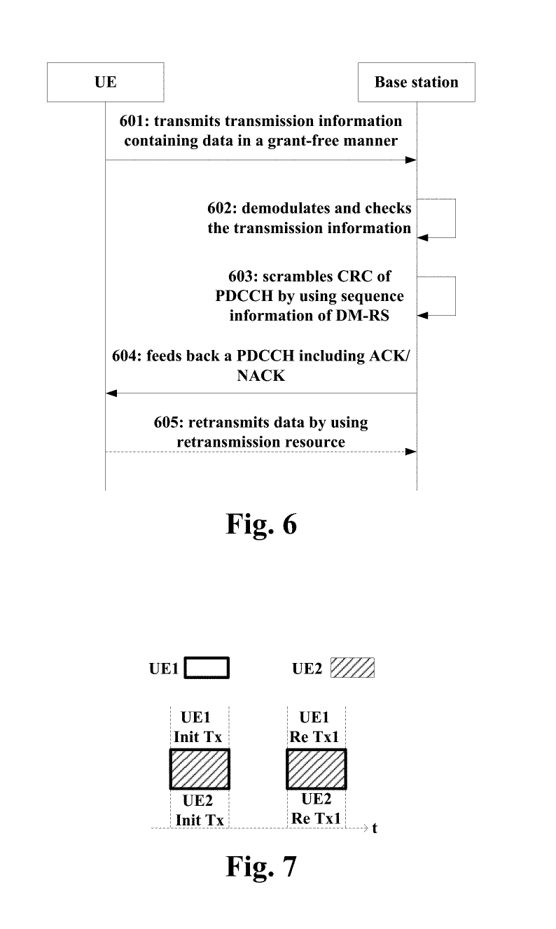

FIG. 6 is a schematic diagram of the information transmission method of the embodiment of this disclosure, which shall be described by taking a base station and a user equipment as examples. As shown in FIG. 6, the information transmission method includes:

601: a user equipment transmits transmission information containing data in a grant-free manner to a base station;

identification information of the transmitting device is explicitly carried in the transmission information, as shown in FIG. 5.

602: the base station demodulates and checks the transmission information, and determines whether the identification information of the transmitting device and the data are correctly obtained.

In an embodiment, the base station may obtain sequence information of the DM-RS by blind detection, demodulate the transmission information according to the DM-RS, and check the check code to obtain the identification information of the transmitting device and the data.

Since the UE ID and the data jointly generate a CRC, when the checking of the CRC is incorrect, the base station is unable to distinguish whether there is an error of the UE ID, or an error of the data, or both. This means that when the base station feeds back an NACK, as the base station is unable to learn an accurate UE ID in advance, the CRC of the PDCCH may not be scrambled by using the UE ID, that is, a user equipment of which initial transmission of data is incorrect is unable to be addressed via the UE ID.

603: the base station scrambles the CRC of the PDCCH by using the sequence information of the DM-RS.

604: the base station feeds back a PDCCH including ACK/NACK to the user equipment.

In an embodiment, the CRC of the PDCCH may be scrambled by using the DM-RS ID m, that is, the DM-RS ID is used instead of the UE ID to address the user equipment, and the ACK and NACK feedback may respectively notify the scrambled PDCCH to the user equipment in this manner.

Furthermore, for uplink grant-free transmission, there may also exist a case of miss-detection by the base station, that is, the base station does not detect existence of the user equipment. The occurrence of such a case is due to the fact that the base station does not detect a DM-RS and/or spreading sequences/codewords/interleaving patterns. In this case, the base station will not transmit any PDCCH scrambled according to the DM-RS sequence index to the user equipment.

For the user equipment, it will detect whether there exists a PDCCH carrying ACK/NACK at a fixed moment after initiating the transmission, that is, whether there exists a PDCCH that is scrambled by using the DM-RS ID used in a last transmission.

More particularly, the user equipment may learn which of the states of the ACK, the NACK and miss-detection it is currently in by detecting the PDCCH. For example, when the user equipment detects the PDCCH that is scrambled by using the DM-RS ID used in a last transmission, the user equipment may learn whether it is currently in the ACK or the NACK state according to a corresponding field in the PDCCH (such as a new data indicator (NDI)); and when the user equipment initiates data transmission but does not detect the PDCCH that is scrambled by using the DM-RS ID used in a last transmission, the user equipment will determine that the current state is a state that the base station missed in detecting the data.

The user equipment may take different subsequent actions according to different states, for example:

after receiving the ACK, the user equipment may wait for new data transmission;

and after receiving the NACK, the user equipment may perform retransmission with a redundancy version to enable the base station to perform HARQ soft combining; since PDCCH signaling is used to indicate the NACK and schedule the retransmission, a new PDCCH format may be defined, and parameters used by the user equipment in retransmission, such as a modulation mode, a redundancy version (RV), a DM-RS sequence, a spreading sequence/codeword/interleaving pattern, and retransmission time-frequency resource positions, may be configured by adding corresponding fields to the signaling, so as to achieve adaptive retransmission. If considering from a point of view of saving PDCCH signaling overhead, the above other fields may be omitted, and only the NACK is transmitted. In this case, the user equipment will still use the same parameters as the last transmission for retransmission, and the selection of the redundancy version will follow rules agreed with the base station in advance, which is equivalent to non-adaptive retransmission.

How to notify the ACK/NACK in the grant-free transmission is illustrated above through the PDCCH by taking the base station and the user equipment as examples; however, this disclosure is not limited thereto. How to perform retransmission in the grant-free transmission shall be schematically illustrated below.

As shown in FIG. 6, the information transmission method may further include:

605: the user equipment retransmits data to the base station by using the retransmission resource.

In an embodiment, the retransmission resource may be a retransmission time, a retransmission frequency position, or a retransmitted time-frequency resource. If the retransmission resource is always defined at a fixed time-frequency position from the initial transmission or the ACK/NACK, a problem brought about by the grant-free transmission is that collision will always occur in the retransmission for a user equipment with initial transmission collision.

FIG. 7 is a schematic diagram of collision occurred in retransmission in grant-free transmission. As shown in FIG. 7, a user equipment 1 and a user equipment 2 always collide, which is adverse to demodulation of data of the user equipments by the base station.

In order to avoid collision in the retransmission, a method may be configuring the retransmission resource of the user equipment by the base station in the signaling notifying the user equipment of the NACK, in which case the retransmission of the user equipment will become grant-based transmission. Hence, collision may be avoided, but correspondingly, additional signaling overhead is needed.

Furthermore, it may be considered to use a random method to determine the retransmission resource, but the user equipment is not allowed to randomly select the retransmission resource, because this will make the base station to be unable to distinguish the initial transmission from the retransmission, thereby being unable to perform HARQ combining.

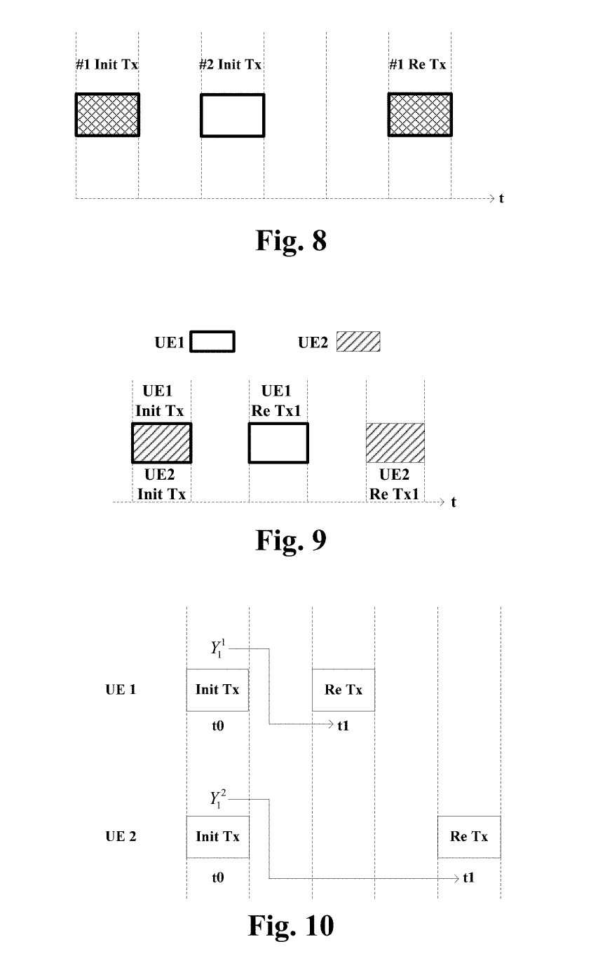

FIG. 8 is a schematic diagram of retransmitting data by randomly selected resources. As shown in FIG. 8, for the initial transmission of a data packet #2, if it occurs between initial transmission of a data packet #1 and a time of retransmission of the data packet #1, when the base station blindly detects the data packet #2, it will not be able to distinguish whether the data packet is new initially transmitted data or retransmitted data of the data packet #1, since the two data packets belong to the same user equipment.

In an embodiment, the resource for transmitting the retransmission data is pseudo-randomly determined according to the sequence index of the DM-RS. For example, the resource for transmitting the retransmission data is determined according to the number of retransmission resources and a DM-RS correlation value, the DM-RS correlation value changing along with the number of times of transmission and an initial value thereof being the sequence index of the DM-RS for initially transmitting the transmission information.

For example, the retransmission resource may be determined according to the formula below:

Iₖ=Yₖ mod R

Yₖ₊₁=f(Yₖ);

where, Iₖ denotes a retransmission resource index, R denotes a total number of resource available for the retransmission; and a recursive function Yₖ₊₁=f(Yₖ) may be defined; where, f(.) denotes function transform, and k denotes a k-th time of retransmission; Y₁=m₀; where, m₀ denotes a DM-RS ID used in the initial transmission.

Hence, a resource used for a first time of retransmission is determined according to Y₁, and a resource used for a second time of retransmission is determined according to Y₂, and so on. The recursive function is used to make values of Yₖ varied in each time of retransmission, so as to bring randomness to the selection of the retransmission resource.

For example, a recursive form determining a PDCCH search space, i.e. Yₖ₊₁=(A·Yₖ) mod D, may be reused; where, D=max {DMRS ID}+1, i.e. a maximum value of the DM-RS ID plus 1, and various selections are available for values of A.

Thus, determination of the retransmission resource of the user equipment in the pseudo-random method may homogenize the collision to some extent, and relieve and avoid occurrence of centralized and continual collision.

FIG. 9 is an exemplary diagram of performing data retransmission of the embodiment of this disclosure, and FIG. 10 is another exemplary diagram of performing data retransmission of the embodiment of this disclosure, in which examples of determining retransmission moments in the pseudo-random method are given. As shown in FIGS. 9 and 10, assuming that retransmission is performed within a subframe or slot R, although collision occurs in the initial transmission of user equipment 1 and user equipment 2, as values of Iₖ of the two user equipments are different (Y₁¹ mod R≠Y₁² mod R; where, the superscripts denote the user equipments, and the subscripts denote the number of times of retransmission), no collision occurs in a first time of retransmission of user equipment 1 and user equipment 2.

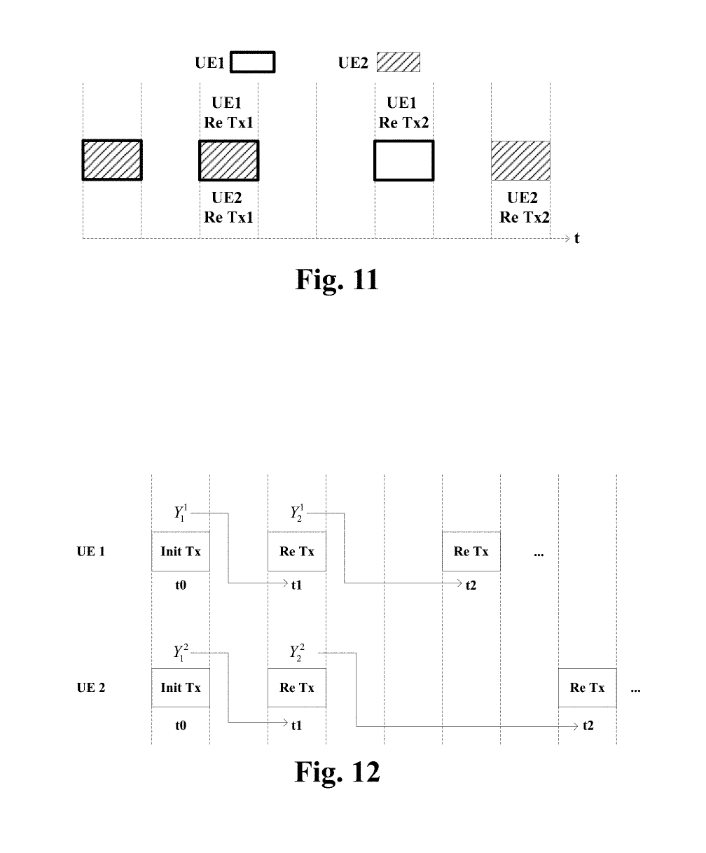

FIG. 11 is a further exemplary diagram of performing data retransmission of the embodiment of this disclosure, and FIG. 12 is yet another exemplary diagram of performing data retransmission of the embodiment of this disclosure. As shown in FIGS. 11 and 12, assuming that retransmission is performed within a subframe or slot R and collision occurs in the initial transmission of two user equipments, if mod Y₁¹=Y₁² mod R, collision still occurs in a first time of retransmission; however, if Y₂¹ mod R≠Y₂² mod R, collision may be avoided in a second time of retransmission.

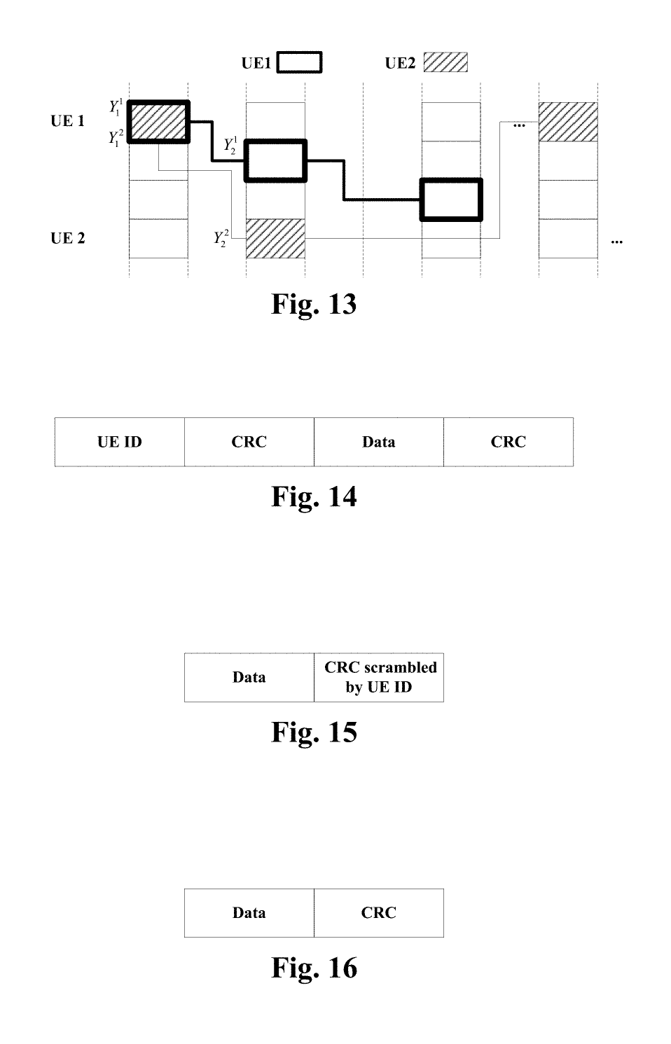

FIG. 13 is still another exemplary diagram of performing data retransmission of the embodiment of this disclosure, which shall be schematically described by taking that the retransmission resources are time-frequency blocks as an example. At this case, R denotes a total number of the time-frequency resource blocks, and it is assumed that the retransmission is performed within a range of R time-frequency resource blocks. As shown in FIG. 13, by using Yₖ, the initial transmission and each time of retransmission of the user equipments may be made to jump between different time-frequency resource blocks, thereby avoiding occurrence of continual collision between the user equipments.

In an embodiment, when the user equipment determines that it is in the missed detection state, the user equipment will repeatedly transmit data of the last transmission version (which is sometimes the initial transmission version, and sometimes a redundant version to which the last transmission corresponds, depending on different numbers of times of retransmission of the user equipment), without performing transmission of a new redundant version. This is because that the missed detection causes that the base station does not reserve information of the last transmission of the user equipment, and even if the base station receives the new redundancy version transmitted by the user equipment, the base station is unable to perform soft combining by using incremental redundancy, hence, it is unnecessary for the user equipment to perform retransmission of the new redundancy version. This is actually a UE behavior newly defined for the grant-free transmission, which is different from the LTE. In the LTE, after a user equipment initiates data transmission, a case where ACK and NACK are not received will not occur.

The above description is mainly given for a case where the user equipment has only one HARQ process. When the user equipment initiates multiple HARQ processes, there may possibly exist physical resource collision in retransmission or initial transmission in different HARQ processes, such as collision occurred between retransmission of HARQ process 1 and retransmission of HARQ process 2.

This problem may be avoided in one of the following methods or a combination thereof:

1. defining a user behavior; when the user equipment needs to perform initial transmission of an HARQ process #j and retransmission of an HARQ process #k, the user equipment preferentially performs the retransmission of the HARQ process #k, that is, a priority of the retransmission is higher than that of the initial transmission;

2. using an HARQ process ID in determination of a retransmission resource, that is, the DM-RS ID and the HARQ process ID are used together to determine the retransmission, i.e. let Y₁=m₀+HAR [symbol] ID, so as to avoid occurrence of collision between different HARQ processes belonging to the same user equipment;

3. scheduling by the base station; when the base station determines that a user equipment initiates transmission of a new HARQ process when a certain HARQ process has not come to an end, under a condition that the number of DM-RS sequence resources allows, different DM-RS sequences may be configured for different HARQ processes of the user equipment. In this way, retransmission of the different HARQ processes may be allowed to use different DM-RS sequences, hence, the base station is enabled to achieve demodulation respectively.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 3

These embodiments of this disclosure provide an information transmission method, in which this disclosure is further described on the basis of embodiments 1 and 2. However, these embodiments are not limited to the selection of a DM-RS in Embodiment 1, and is also applicable to a case where a user equipment randomly selects a DM-RS or a base station configures a DM-RS for a user equipment. In these embodiments, the transmission information includes the data, a first check code generated according to the data, the identification information of the transmitting device and a second check code generated according to the identification information, with contents identical to those in embodiments 1 and 2 being not going to be described herein any further.

FIG. 14 is a schematic diagram of transmitting information of the embodiment of this disclosure. As shown in FIG. 14, the UE ID is taken as a part of payload of the data and transmitted by the user equipment to the base station. In comparison with Embodiment 2, a CRC corresponding to the UE ID is added into the data transmitted by the user equipment in these embodiments, the CRC being used to check the UE ID. When the CRC is correct, it shows that the UE ID is correctly recovered; and when the CRC is incorrect, it shows that the UE ID is incorrect. For transmission of the UE ID and its CRC, channel codes and/or physical resources different from the part of the data may be used, that is, the transmission of the UE ID is independent from transmission of the data.

In an embodiment, according to whether the UE ID is correctly received and whether the data are correctly received, the following three states, MISS, ACK, and NACK, may be defined:

MISS: the MISS state includes the following three cases:

1. the base station misses detecting the user equipment, that is, the base station does not detect presence of the user equipment; occurrence of such a case is usually due to that the base station does not detect the DM-RS and/or the spreading sequences/codewords/interleaving patterns; and at this case, the base station does not feed back any ACK/NACK information to the user equipment;

2. reception of the UE ID is incorrect but reception of the data is correct; occurrence of such a case is due to that checking of the UE ID CRC is incorrect, but checking of the data CRC is correct;

3. reception of the UE ID is incorrect and reception of the data is incorrect; occurrence of such a case is due to that check of UE ID CRC is incorrect and checking of the data CRC is incorrect.

Since the base station is lack of information on initial transmission in the above case 1, and the base station does not know the UE ID in case 2 or 3, which will result in that the base station is unable to perform HARQ combining, hence, the three cases may be generalized into one state, i.e. the MISS state.

ACK: checking of the UE ID CRC and checking of the data CRC are both correct, and at this case, the base station has obtained the UE ID.

NACK: checking of the UE ID CRC is correct, but checking of the data CRC is incorrect, at this case, the base station has obtained the UE ID, but the reception of the data of the user equipment is incorrect.

These embodiments shall be described below from the base station side and the user equipment side, respectively. It should be noted that only those different from Embodiment 2 shall be described here, and those identical to Embodiment 2 will not be described further.

In an embodiment, the base station may use the PDCCH signaling to feed back ACK/NACK to the user equipment.

When the base station is in the MISS state, the base station does not feed back any ACK/NACK information to the user equipment, that is, it does not transmit the PDCCH; when the base station is in the ACK state, the base station feeds back ACK information to the user equipment via the PDCCH, notifying the user equipment that the data have been correctly received, the CRC of the PDCCH being scrambled by using the UE ID; and when the base station is in the NACK state, the base station uses the PDCCH signaling to feed back the NACK to the user equipment and schedules retransmission, the CRC of the PDCCH being scrambled by using the UE ID.

In an embodiment, the user equipment will detect whether there exists a PDCCH carrying ACK/NACK at a certain fixed moment after the transmission is initiated, that is, detecting whether there exists a PDCCH that is scrambled by using the UE ID. And the user equipment may learn which state of the MISS, ACK, and NACK it is currently in by detecting the PDCCH.

When the user equipment detects the PDCCH scrambled by using its own UE ID, the user equipment will learn whether it is currently in the ACK or NACK state according to a corresponding field (such as an NDI) in the PDCCH; and when the user equipment initiates data transmission but does not detect the PDCCH scrambled by using its own UE ID, the user equipment will determine that the current state is MISS.

The user equipment may take different subsequent behaviors according to different states, for example:

1. after receiving the ACK, the user equipment may wait for new data transmission;

2. after receiving the NACK, the user equipment may perform retransmission with a redundancy version.

For the determination of the retransmission resource of the user equipment, since the UE ID is known at the base station side, the UE ID may be used to determine the retransmission resource.

For example, let an initial value Y₁=UE ID, and other steps or blocks for determining the retransmission resource are identical to those in Embodiment 2. For example, Yₖ₊₁=(A·Yₖ) mod D may be used; where, D=max {UE ID}+1, i.e. a maximum value of the UE ID plus 1, and various selections are available for values of A. If the UE ID is of 16 bits, parameters D=65537, A=39827 used by the PDCCH in defining a search space may be reused.

3. when the user equipment determines that it is in the MISS state, the user equipment will repeatedly transmit data of the last transmission version (which is sometimes the initial transmission version, and sometimes a redundant version to which the last transmission corresponds, depending on different numbers of times of retransmission of the user equipment).

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 4

These embodiments of this disclosure provide an information transmission method, in which this disclosure is further described on the basis of embodiments 1-3. In these embodiments, the transmission information includes the data and a check code generated according to the data; the check code is scrambled by the identification information of the transmitting device, with contents identical to those in embodiments 1-3 being not going to be described herein any further.

FIG. 15 is a schematic diagram of information transmission of the embodiment of this disclosure. As shown in FIG. 15, the UE ID is not transmitted in a data area, rather, a CRC is scrambled by using the UE ID. The UE ID is not needed to be carried in the data in these embodiments, but the base station may be enabled to recover the UE ID.

In an embodiment, the base station blindly detects DM-RSs, performs equivalent channel estimation for each detected DM-RS, uses a result for demodulation of spreading sequences/codewords/interleaving patterns associated with the DM-RS, and finally uses all possible UE IDs to descramble the CRC, a UE ID enabling the CRC to be successfully descrambled corresponding to a user equipment currently performing data transmission.

The descrambling of the UE ID in the embodiment requires exhaustive attempts to all UE IDs to select a current DM-RS, but this does not mean too much complexity added. For example, for the DM-RS sequence selection method of Embodiment 1, each DM-RS sequence corresponds to U/M possible UE IDs, which means that only a small part of UE IDs have the possibility of using the DM-RS, hence, the CRC descrambling attempts needs only to be performed for this part of UE IDs. For example, if the number of user equipments is 10 times the number of DM-RS sequences, i.e. U/M=10, each DM-RS only needs to attempt descrambling matching of 10 UE IDs, rather than all UE IDs.

The condition that there is no matching between a UE ID and a CRC means a CRC is incorrect, the base station is needed to notify the user equipment to perform retransmission. For the notification of ACK and NACK, the CRC of the PDCCH may be scrambled by using the DM-RS ID, which may be identical to that in Embodiment 2. For the determination of the retransmission resource, the DM-RS ID may also be used, which may be identical to that in Embodiment 2.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 5

These embodiments of this disclosure provide an information transmission method, in which this disclosure is further described on the basis of embodiments 1-4. However, these embodiments are not limited to the selection of a DM-RS in Embodiment 1, and are also applicable to a case where a user equipment randomly selects a DM-RS or a base station configures a DM-RS for a user equipment. In these embodiments, the transmission information includes the data and a check code generated according to the data. Correspondence between DM-RSs and the identification information of the transmitting device is predetermined, with contents identical to those in embodiments 1-4 being not going to be described herein any further.

FIG. 16 is a schematic diagram of information transmission of the embodiment of this disclosure. As shown in FIG. 16, since the correspondence between the DM-RSs and the UE IDs is predetermined, the base station can determine the used DM-RS by blind detection, and then learn the UE ID through the correspondence between the DM-RSs and the UE IDs. Therefore, the UE ID does not need to be transmitted in a valid data payload, that is, it does not need to carry UE ID information in the uplink data transmission.

In an embodiment, the DM-RSs may be in one-to-one correspondence with the UE IDs. For example, the base station may configure the DM-RS used by the user equipment via signaling, and in some cases (such as a case that the number of DM-RS sequences is greater than the number of user equipments), DM-RS sequences used by user equipments of different UE IDs may be made different.

Since the base station may determine and obtain the UE ID by blindly detecting the DM-RS sequence, ACK/NACK feedback and determining retransmission resources may be performed by using a method similar to that of Embodiment 3.

That is, when the base station misses in detection the DM-RS, the base station does not use the PDCCH signaling to transmit the ACK/NACK to the user equipment; when the base station detects that the CRC is incorrect, the base station uses the UE ID to scramble the CRC of the PDCCH, and uses the PDCCH to transmit the NACK; and when the base station detects that the CRC is correct, the base station scrambles the CRC of the PDCCH by using the UE ID, and transmits the ACK by using the PDCCH.

When the user equipment initiates data transmission but does not receive any ACK/NACK indication, the user equipment will retransmit the last transmission version, rather than transmit a new redundancy version. The retransmission resource may be determined by using the UE ID, a particular method being identical to that in Embodiment 3.

Furthermore, since there exists a correspondence between the DM-RSs and the UE IDs, the CRC of the PDCCH may also be scrambled by using the DM-RS ID, and thus the ACK/NACK feedback and the determination of the retransmission resource may be performed by using a method similar to that of Embodiment 2.

That is, when the base station misses in detecting the DM-RS, the base station does not use the PDCCH signaling to transmit ACK/NACK to the user equipment; when the base station detects that the CRC is incorrect, the base station uses the DM-RS ID to scramble the CRC of the PDCCH, and uses the PDCCH to transmit the NACK; and when the base station detects that the CRC is correct, the base station scrambles the CRC of the PDCCH by using the DM-RS ID, and transmits the ACK by using the PDCCH.

When the user equipment initiates data transmission but does not receive any ACK/NACK indication, the user equipment will retransmit the last transmission version, rather than transmit a new redundancy version. The retransmission resource may be determined by using the DM-RS ID, a particular method being identical to that in Embodiment 3.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 6

These embodiments of this disclosure provide an information transmission method, in which this disclosure is further described on the basis of embodiments 1-5. Different from embodiments 2-5 using a PDCCH, a PHICH is used in these embodiments for performing ACK/NACK feedback, with contents identical to those in embodiments 1-5 being not going to be described herein any further.

In an embodiment, a PHICH is used in the grant-free transmission, and a logic resource addressing manner needs to be modified. Here, a logic resource of the PHICH is determined by using a DM-RS ID and/or a UE ID.

For example, a position of the logic resource of the PHICH is determined according to a DM-RS ID m, that is, the logic resource is determined according to formulae as below:

n_{PHICH}^{group}=m mod N_{PHICH}^{group},

n_{PHICH}^{seq}=└m/n_{PHICH}^{group}┘ mod 2N_{SF}^{PHICH};

or, the position of the logic resource of the PHICH is determined according to a UE ID, that is, the position of the logic resource of the PHICH is determined according to formulae as below:

n_{PHICH}^{group}=UE ID mod N_{PHICH}^{group},

n_{PHICH}^{seq}=(└UE ID/N_{PHICH}^{group}┘ mod 2N_{SF}^{PHICH};

where, definitions of the above parameters may follow the LTE standard 36.213; n_{PHICH}^{group} denotes a PHICH group index, n_{PHICH}^{seq} denotes an orthogonal sequence index within the PHICH group, and N_{SF}^{PHICH} denotes a size of a spreading factor.

As the PHICH carries only the ACK/NACK information, non-adaptive retransmission is usually used in the retransmission, that is, a modulation scheme, DM-RS sequences, and spreading sequences/codewords/interleaving patterns, etc., used in the retransmission, are identical to those used in the initial transmission.

Furthermore, as the user equipment only outputs a binary determination result in detecting the PHICH, i.e. the ACK or NACK, and is unable to learn a MISS state, the user equipment will be unable to distinguish between the NACK and the MISS. In this case, the user equipment may be made to always retransmit an initially transmitted version.

### Embodiment 7

These embodiments of this disclosure provide an information transmission method, in which this disclosure is further described on the basis of embodiments 1-6.

For the method for determining retransmission resource Iₖ=Yₖ mod R, Yₖ₊₁=f(Yₖ) in embodiments 2 and 3, Y₁ is determined in the initial transmission, and is further used for determining positions of resources for subsequent retransmission. If let Y₁ always take the same value, for example, the value may be a UE ID, it means that for a user equipment, resources used by it in a k-th time of retransmission are always identical.

A method for further enhancing retransmission randomization shall be given in these embodiments.

A value of Yₖ is determined at a (k−1)-th time of transmission (here, it is defined that a 0-th time of transmission is initial transmission, and so on; and a k-th time of transmission corresponds to a k-th time of retransmission), for the k-th time of retransmission, a position of its retransmission resource is determined according to Yₖ. Here, the definition of Yₖ is extended, and Yₖ is redefined as Y_{k,t}, denoting that the (k−1)-th time of transmission occurs at a time t, and a time dimension being newly added.

For example, Zₜ=g(Zₜ₋₁) is defined; where t=0, 1, 2, . . . , T, t denoting a time for performing the data transmission, such as a subframe in the LTE; T is used to limit a range of values of t, denoting a maximum value that may be taken by t, for example, a maximum subframe index in the LTE is 9; and the function g(.) denotes recursive function transform.

For example, a recursive form of the search space of the PDCCH may be reused, i.e. Zₜ=(A·Zₜ₋₁) mod D; where, D=max {UE ID}+1 or D=max {DMRS ID}+1; various selections are available for values of A, and Z₋₁ is an initial value, which may be equal to a UE ID or a DM-RS ID.

For the (k−1)-th time of transmission occurs at the time t, Y_{k,t}=Zₜ is calculated, and then Iₖ=Y_{k,t} mod R is used to determine a resource at the k-th time of transmission. Here, the resource used at the k-th time of transmission is still determined according to Y_{k,t} to which a last transmission (i.e. the k-th time of transmission) corresponds.

What is different from the last embodiments is that Y_{k,t} in the embodiment varies along with the time t, and in embodiments 2 and 3, once the initial value Y₀ is determined, Yₖ will be subsequently determined accordingly. Hence, the embodiment is able to provide a relatively large random selection space.

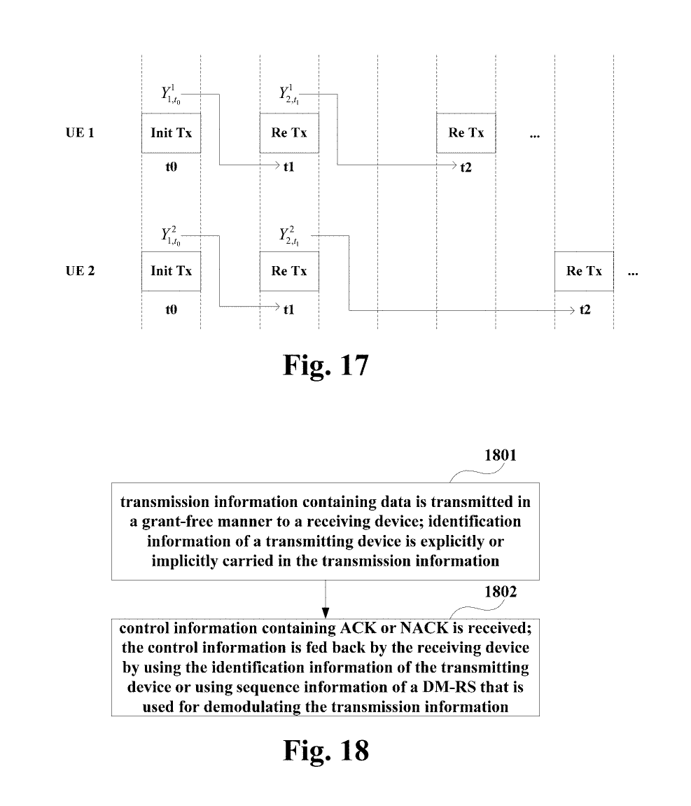

FIG. 17 is an exemplary diagram of performing data retransmission of the embodiment of this disclosure. As shown in FIG. 17, the embodiment is able to enhance retransmission randomization.

### Embodiment 8

These embodiments of this disclosure provide an information transmission method, applicable to a transmitting device, with contents identical to those in embodiments 1-7 being not going to be described herein any further.

FIG. 18 is a schematic diagram of the information transmission method of the embodiment of this disclosure. As shown in FIG. 18, the information transmission method includes:

Block 1801: transmission information containing data is transmitted in a grant-free manner to a receiving device; identification information of a transmitting device is explicitly or implicitly carried in the transmission information; and

Block 1802: control information containing acknowledgment or non-acknowledgment is received; the control information is fed back by the receiving device by using the identification information of the transmitting device or using sequence information of a demodulation reference signal that is used for demodulating the transmission information.

In an embodiment, the transmission information may include the data, the identification information of the transmitting device and a check code generated according to the data and the identification information; or, the transmission information may include the data, a first check code generated according to the data, the identification information of the transmitting device and a second check code generated according to the identification information; or, the transmission information may include the data and a check code generated according to the data, the check code is scrambled according to the identification information of the transmitting device; or, the transmission information may include the data and a check code generated according to the data, a correspondence between the demodulation reference signal and the identification information of the transmitting device is predetermined.

In an embodiment, a range of the DM-RS is preconfigured, and a sequence index of the DM-RS is pseudo-randomly determined according to the identification information of the transmitting device.

For example, the DM-RS is determined according to the number of sequences and a user equipment correlation value, the user equipment correlation value changing along with a change of the number of times of transmission, and its initial value being the identification information of the transmitting device.

In an embodiment, when the control information containing NACK is received, or when the control information containing ACK/NACK is not received, data may be retransmitted to the receiving device; resources for transmitting retransmission data are pseudo-randomly determined according to the sequence index of the DM-RS or the identification information of the transmitting device.

For example, the resources for transmitting the retransmission data are determined according to the number of retransmission resources and a DM-RS correlation value, the DM-RS correlation value changing along with the change of the number of times of transmission, and its initial value being the sequence index of the demodulation reference signal for initially transmitting the transmission information;

or the resources for transmitting the retransmission data are determined according to the number of retransmission resources and a user equipment correlation value, the user equipment correlation value changing along with a change of the number of times of transmission, and its initial value being the identification information of the transmitting device.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 9

These embodiments of this disclosure provide an information transmission apparatus, configured in a receiving device. These embodiments correspond to the information transmission methods in embodiments 1-7, with identical contents being not going to be described herein any further.

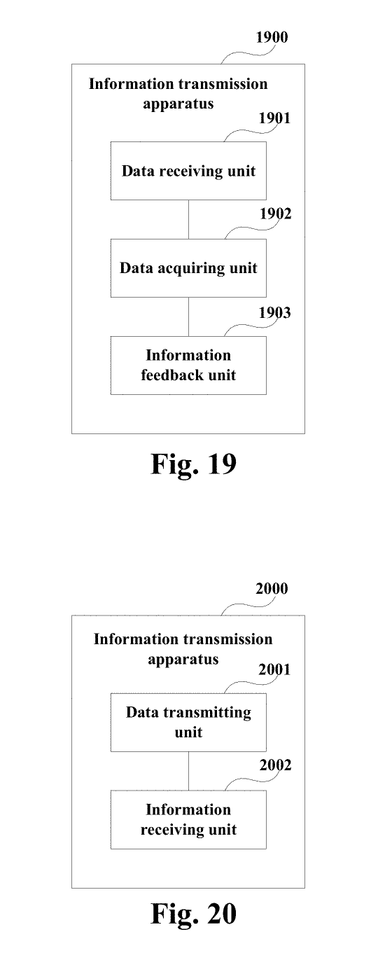

FIG. 19 is a schematic diagram of the information transmission apparatus of the embodiment of this disclosure. As shown in FIG. 19, an information transmission apparatus 1900 includes:

a data receiving unit 1901 configured to receive transmission information containing data, which is transmitted by a transmitting device in a grant-free manner; identification information of the transmitting device is explicitly or implicitly carried in the transmission information;

a data acquiring unit 1902 configured to demodulate and check the transmission information, and determine whether the identification information of the transmitting device and the data contained in the transmission information are correctly obtained; and

an information feedback unit 1903 configured to feed control information containing acknowledgment or non-acknowledgment back to the transmitting device, by using the identification information of the transmitting device or using sequence information of a demodulation reference signal that is used for demodulating the transmission information.

In one embodiment, the transmission information may include the data, the identification information of the transmitting device and a check code generated according to the data and the identification information;

and the data acquiring unit 1902 may further be configured to obtain the sequence information of the demodulation reference signal by blind detection, demodulate the transmission information according to the demodulation reference signal, and verify the check code, to obtain the identification information of the transmitting device and the data.

In another embodiment, the transmission information may include the data, a first check code generated according to the data, the identification information of the transmitting device and a second check code generated according to the identification information;

and the data acquiring unit 1902 may further be configured to obtain the sequence information of the demodulation reference signal by blind detection, demodulate the transmission information according to the demodulation reference signal, verify the first check code to obtain the data and verify the second check code to obtain the identification information of the transmitting device.

In a further embodiment, the transmission information may include the data and a check code generated according to the data; the check code is scrambled according to the identification information of the transmitting device;

and the data acquiring unit 1902 may further be configured to obtain the sequence information of the demodulation reference signal by blind detection, demodulate the transmission information according to the demodulation reference signal, determine a range of the identification information of the transmitting device, descramble and verify the check code by using all identification information in the range, determine the identification information of the transmitting device and obtain the data according to a verification result.

In yet another embodiment, the transmission information may include the data and a check code generated according to the data; a correspondence between the demodulation reference signal and the identification information of the transmitting device is predetermined;

and the data acquiring unit 1902 may further be configured to obtain the sequence information of the demodulation reference signal by blind detection, determine the identification information of the transmitting device and demodulate the transmission information, according to the demodulation reference signal, and verify the check code, to obtain the data.

In an embodiment, a range of the demodulation reference signal is configured, and a sequence index of the demodulation reference signal is pseudo-randomly determined according to the identification information of the transmitting device.

The demodulation reference signal of the transmission information is determined according to the number of sequences of the demodulation reference signal and a user equipment correlation value, the user equipment correlation value changing along with a change of the number of times of transmission, and its initial value being the identification information of the transmitting device.

In an embodiment, the data acquiring unit 1902 may further be configured to determine one or more of a spreading sequence, a codeword, or an interleaving pattern according to the demodulation reference signal, and transform the transmission information according to one or more of the spreading sequence, the codeword, or the interleaving pattern.

In an embodiment, the data receiving unit 1901 may further be configured to receive retransmission data transmitted by the transmitting device; one or more resources for transmitting the retransmission data is/are pseudo-randomly determined according to the sequence index of the demodulation reference signal or the identification information of the transmitting device.

The resources for transmitting the retransmission data are determined according to the number of retransmission resources and a demodulation reference signal correlation value, the demodulation reference signal correlation value changing along with the change of the number of times of transmission, and its initial value being the sequence index of the demodulation reference signal for initially transmitting the transmission information.

Or, the resources for transmitting the retransmission data are determined according to the number of the retransmission resources and a user equipment correlation value, the user equipment correlation value changing along with the change of the number of times of transmission, and its initial value being the identification information of the transmitting device.

In an embodiment, the control information containing acknowledgment or non-acknowledgment may be carried in a PDCCH; and the information feedback unit 1903 may be configured to scramble check information on the physical downlink control channel by using the identification information of the transmitting device or the sequence index of the demodulation reference signal of the transmission information.

In an embodiment, the control information containing acknowledgment or non-acknowledgment may be carried in a PHICH; and the information feedback unit 1903 may further be configured to determine a logic resource position of the PHICH by using the sequence index of the demodulation reference signal or the identification information of the transmitting device.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 10

These embodiments of this disclosure provide an information transmission apparatus, configured in a transmitting device. These embodiments correspond to the information transmission method in Embodiment 8, with identical contents being not going to be described herein any further.

FIG. 20 is a schematic diagram of the information transmission apparatus of the embodiment of this disclosure. As shown in FIG. 20, an information transmission apparatus 2000 includes:

a data transmitting unit 2001 configured to transmit transmission information containing data in a grant-free manner to a receiving device; identification information of the transmitting device is explicitly or implicitly carried in the transmission information; and

an information receiving unit 2002 configured to receive control information containing acknowledgment or non-acknowledgment fed back by the receiving device, by using the identification information of the transmitting device or using sequence information of a demodulation reference signal that is used for demodulating the transmission information.

In an embodiment, the transmission information may include the data, the identification information of the transmitting device and a check code generated according to the data and the identification information; or, the transmission information may include the data, a first check code generated according to the data, the identification information of the transmitting device and a second check code generated according to the identification information; or, the transmission information may include the data and a check code generated according to the data, the check code is scrambled according to the identification information of the transmitting device; or, the transmission information may include the data and a check code generated according to the data, a correspondence between the demodulation reference signal and the identification information of the transmitting device is predetermined.

In an embodiment, a range of the demodulation reference signal is configured, and a sequence index of the demodulation reference signal is pseudo-randomly determined according to the identification information of the transmitting device.

The demodulation reference signal of the transmission information may be determined according to the number of sequences of the demodulation reference signal and a user equipment correlation value, the user equipment correlation value changing along with a change of the number of times of transmission, and its initial value being the identification information of the transmitting device.

In an embodiment, the data transmitting unit 2001 may further be configured to retransmit a designated redundancy version when the control information containing non-acknowledgment is received, and transmit data identical to that transmitted last time to the receiving device when neither the control information containing acknowledgment nor the control information containing non-acknowledgment is received; one or more resources for transmitting retransmission data is/are pseudo-randomly determined according to the sequence index of the demodulation reference signal or the identification information of the transmitting device.

For example, the resources for transmitting the retransmission data may be determined according to the number of retransmission resources and a demodulation reference signal correlation value, the demodulation reference signal correlation value changing along with the change of the number of times of transmission, and its initial value being the sequence index of the demodulation reference signal for initially transmitting the transmission information;

or the resources for transmitting the retransmission data may be determined according to the number of retransmission resources and a user equipment correlation value, the user equipment correlation value changing along with a change of the number of times of transmission, and its initial value being the identification information of the transmitting device.

It can be seen from the above embodiments that the identification information of the transmitting device is explicitly or implicitly carried in the transmission information, and the identification information of the transmitting device or the sequence information of a DM-RS is used to feed back control information containing ACK/NACK to the transmitting device. Hence, in performing transmission in a grant-free manner, even though the receiving device is unable to correctly obtain the data transmitted by the transmitting device, it may feed back NACK information based on the identification information of the transmitting device or the sequence information of the demodulation reference signal, thereby achieving high-efficiency data retransmission in a case of transmission in a grant-free manner.

### Embodiment 11

These embodiments of this disclosure provide a communication system, with contents identical to those in embodiments 1-10 being not going to be described herein any further.

In an embodiment, the communication system may include:

a transmitting device configured with the information transmission apparatus 2000 as described in Embodiment 10; and

a receiving device configured with the information transmission apparatus 1900 as described in Embodiment 9.

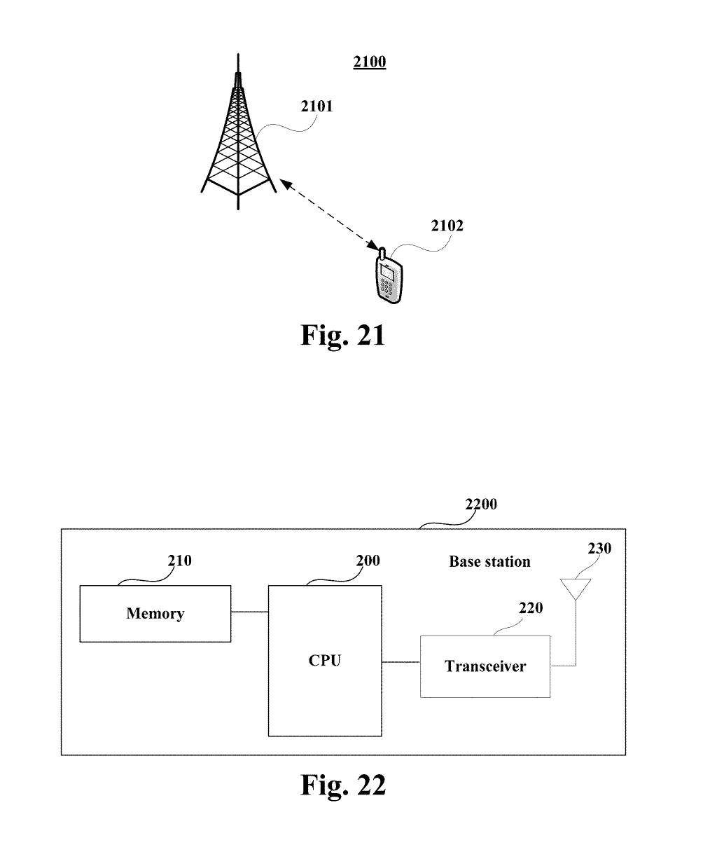

FIG. 21 is a schematic diagram of the communication system of the embodiment of this disclosure, schematically describing a case where the transmitting device is a user equipment and the receiving device is a base station. As shown in FIG. 21, the communication system 2100 may include a base station 2101 and a user equipment 2102. The base station 2101 is configured with the information transmission apparatus 1900 as described in Embodiment 9, and the user equipment 2102 is configured with the information transmission apparatus 2000 as described in Embodiment 10.

The embodiment of this disclosure further provides a receiving device, which may be, for example, a base station. However, this disclosure is not limited thereto, and it may also be other network devices. And following description shall be given by taking a base station as an example.

FIG. 22 is a schematic diagram of a structure of the base station of the embodiment of this disclosure. As shown in FIG. 22, the base station 2200 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The central processing unit 200 may be configured to carry out the functions of the information transmission apparatus 1900.

For example, the central processing unit 200 may be configured to perform following control: receiving transmission information containing data transmitted by a transmitting device in a grant-free manner; identification information of the transmitting device is explicitly or implicitly carried in the transmission information; demodulating and checking the transmission information, and determining whether the identification information of the transmitting device and the data contained in the transmission information are correctly obtained; and feeding control information containing acknowledgment or non-acknowledgment back to the transmitting device by using the identification information of the transmitting device or sequence information of a demodulation reference signal used for demodulating the transmission information.

Furthermore, as shown in FIG. 22, the base station 2200 may include a transceiver 220, and an antenna 230, etc. Functions of the above components are similar to those in the relevant art, and shall not be described herein any further. It should be noted that the base station 2200 does not necessarily include all the parts shown in FIG. 22, and furthermore, the base station 2200 may include parts not shown in FIG. 22, and the relevant art may be referred to.

The embodiment of this disclosure further provides transmitting device, which may be, for example, a user equipment. However, this disclosure is not limited thereto, and it may also be other network devices. And following description shall be given by taking a user equipment as an example.

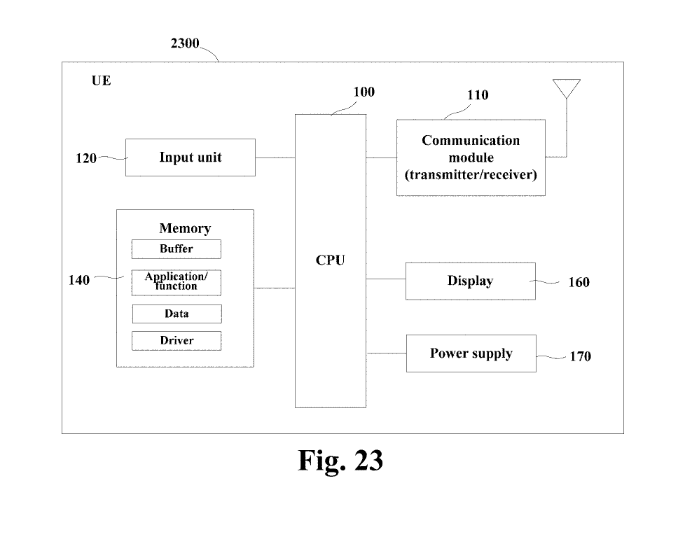

FIG. 23 is a schematic diagram of the user equipment of the embodiment of this disclosure. As shown in FIG. 23, the user equipment 2300 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

The central processing unit 100 may be configured to carry out the functions of the information transmission apparatus 2000.

For example, the central processing unit 100 may be configured to perform following control: transmitting transmission information containing data in a grant-free manner to a receiving device; identification information of the transmitting device is explicitly or implicitly carried in the transmission information; and receiving control information containing acknowledgment or non-acknowledgment fed back by the receiving device by using the identification information of the transmitting device or sequence information of a demodulation reference signal used for demodulating the transmission information.

As shown in FIG. 23, the user equipment 2300 may further include a communication module 110, an input unit 120, a display 160 and a power supply 170. Functions of the above components are similar to those in the relevant art, and shall not be described herein any further. It should be noted that the user equipment 2300 does not necessarily include all the parts shown in FIG. 23, and the above components are not necessary; and furthermore, the user equipment 2300 may include parts not shown in FIG. 23, and the relevant art may be referred to.

An embodiment of the present disclosure provides a computer readable program code, which, when executed in a receiving device or a base station, will cause the receiving device or the base station to carry out the information transmission methods described in embodiments 1-7.

An embodiment of the present disclosure provides a computer readable medium, including a computer readable program code, which will cause a receiving device or a base station to carry out the information transmission methods described in embodiments 1-7.

An embodiment of the present disclosure provides a computer readable program code, which, when executed in a transmitting device or a user equipment, will cause the transmitting device or the user equipment to carry out the information transmission method described in Embodiment 8.

An embodiment of the present disclosure provides a computer readable medium, including a computer readable program code, which will cause a transmitting device or a user equipment to carry out the information transmission method described in Embodiment 8.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The method/apparatus described with reference to the embodiments of this disclosure may be directly embodied as hardware, software modules executed by a processor, or a combination thereof. For example, one or more functional block diagrams and/or one or more combinations of the functional block diagrams shown in FIG. 19 may either correspond to software modules of procedures of a computer program, or correspond to hardware modules. Such software modules may respectively correspond to the steps shown in FIG. 4. And the hardware module, for example, may be carried out by firming the soft modules by using a field programmable gate array (FPGA).

The soft modules may be located in an RAM, a flash memory, an ROM, an EPROM, and an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the figures may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the figures may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

Supplement 1. A data retransmission apparatus, configured in a transmitting device, the data retransmission apparatus including:

a data transmitting unit configured to transmit transmission information containing data to a receiving device in a grant-free manner; and

a data retransmitting unit configured to retransmit a designated redundancy version when control information containing non-acknowledgment is received, and transmit data identical to that transmitted last time to the receiving device when neither control information containing acknowledgment nor control information containing non-acknowledgment is received.

Supplement 2. The data retransmission apparatus according to supplement 1, wherein resources for transmitting retransmission data are pseudo-randomly determined according to a sequence index of a demodulation reference signal.

Supplement 3. The data retransmission apparatus according to supplement 2, wherein the resources for transmitting the retransmission data are determined according to the number of retransmission resources and a demodulation reference signal correlation value, the demodulation reference signal correlation value changing along with the change of the number of times of transmission, and its initial value being the sequence index of the demodulation reference signal for initially transmitting the transmission information.

Supplement 4. The data retransmission apparatus according to supplement 1, wherein resources for transmitting retransmission data are pseudo-randomly determined according to the identification information of the transmitting device.

Supplement 5. The data retransmission apparatus according to supplement 4, wherein resources for transmitting the retransmission data are determined according to the number of retransmission resources and a user equipment correlation value, the user equipment correlation value changing along with a change of the number of times of transmission, and its initial value being the identification information of the transmitting device.

Supplement 6. The data retransmission apparatus according to supplement 1, wherein resources for transmitting retransmission data are pseudo-randomly determined according to a sequence index of a demodulation reference signal and a transmission time.

Supplement 7. The data retransmission apparatus according to supplement 1, wherein resources for transmitting retransmission data are pseudo-randomly determined according to identification information of the transmitting device and a transmission time.

Supplement 8. A data retransmission apparatus, configured in a receiving device, the data retransmission apparatus including:

a data receiving unit configured to receive transmission information containing data, which is transmitted by a transmitting device in a grant-free manner; and

a retransmission receiving unit configured to receive retransmission data transmitted by the transmitting device when control information containing non-acknowledgment is received or when neither control information containing acknowledgment nor control information containing non-acknowledgment is received.

Supplement 9. The data retransmission apparatus according to supplement 8, wherein resources for transmitting retransmission data are pseudo-randomly determined according to a sequence index of a demodulation reference signal.

Supplement 10. The data retransmission apparatus according to supplement 9, wherein the resources for transmitting retransmission data are determined according to the number of retransmission resources and a demodulation reference signal correlation value, the demodulation reference signal correlation value changing along with the change of the number of times of transmission, and its initial value being the sequence index of the demodulation reference signal for initially transmitting the transmission information.

Supplement 11. The data retransmission apparatus according to supplement 8, wherein resources for transmitting retransmission data are pseudo-randomly determined according to the identification information of the transmitting device.

Supplement 12. The data retransmission apparatus according to supplement 11, wherein resources for transmitting retransmission data are determined according to the number of retransmission resources and a user equipment correlation value, the user equipment correlation value changing along with a change of the number of times of transmission, and its initial value being the identification information of the transmitting device.

Supplement 13. The data retransmission apparatus according to supplement 8, wherein resources for transmitting retransmission data are pseudo-randomly determined according to a sequence index of the demodulation reference signal and a transmission time.

Supplement 14. The data retransmission apparatus according to supplement 8, wherein resources for transmitting retransmission data are pseudo-randomly determined according to the identification information of the transmitting device and a transmission time.

What is claimed is:

1. An information transmission apparatus, configured in a receiving device, the information transmission apparatus comprising:
a memory that stores a plurality of instructions; and
a processor coupled to the memory and configured to execute the instructions to:
receive transmission information containing data, which is transmitted by a transmitting device in a grant-free manner; wherein, identification information of the transmitting device is explicitly or implicitly carried in the transmission information;
demodulate and check the transmission information, and determine whether the identification information of the transmitting device and the data contained in the transmission information are correctly obtained; and
feed control information containing acknowledgment or non-acknowledgment back to the transmitting device, by using the identification information of the transmitting device, or using sequence information of a demodulation reference signal that is used for demodulating the transmission information.

2. The information transmission apparatus according to claim 1, wherein the transmission information comprises the data, the identification information of the transmitting device and a check code generated according to the data and the identification information;
and the processor is further configured to obtain the sequence information of the demodulation reference signal by blind detection, demodulate the transmission information according to the demodulation reference signal, and verify the check code to obtain the identification information of the transmitting device and the data.

3. The information transmission apparatus according to claim 1, wherein the transmission information comprises the data, a first check code generated according to the data, the identification information of the transmitting device and a second check code generated according to the identification information;
and the processor is further configured to obtain the sequence information of the demodulation reference signal by blind detection, demodulate the transmission information according to the demodulation reference signal, verify the first check code to obtain the data and verify the second check code to obtain the identification information of the transmitting device.

4. The information transmission apparatus according to claim 1, wherein the transmission information comprises the data and a check code generated according to the data; wherein the check code is scrambled according to the identification information of the transmitting device;
and the processor is further configured to obtain the sequence information of the demodulation reference signal by blind detection, demodulate the transmission information according to the demodulation reference signal, determine a range of the identification information of the transmitting device, descramble and verify the check code by using all the identification information in the range, determine the identification information of the transmitting device and obtain the data according to a verification result.

5. The information transmission apparatus according to claim 1, wherein the transmission information comprises the data and a check code generated according to the data; wherein a correspondence between the demodulation reference signal and the identification information of the transmitting device is predetermined;
and the processor is further configured to obtain the sequence information of the demodulation reference signal by blind detection, determine the identification information of the transmitting device and demodulate the transmission information according to the demodulation reference signal, and verify the check code to obtain the data.

6. The information transmission apparatus according to claim 1, wherein a range of the demodulation reference signal is pre-configured, and a sequence index of the demodulation reference signal is pseudo-randomly determined according to the identification information of the transmitting device.

7. The information transmission apparatus according to claim 6, wherein the demodulation reference signal of the transmission information is determined according to the number of sequences of the demodulation reference signal and a user equipment correlation value, the user equipment correlation value changing along with a change of the number of times of transmission, and its initial value being the identification information of the transmitting device.

8. The information transmission apparatus according to claim 6, wherein the processor is further configured to determine one or more of a spreading sequence, a codeword and an interleaving pattern according to the demodulation reference signal, and transform the transmission information according to one or more of the spreading sequence, the codeword and the interleaving pattern.

9. The information transmission apparatus according to claim 1, wherein the processor is further configured to receive retransmission data transmitted by the transmitting device; wherein one or more resources for transmitting the retransmission data is/are pseudo-randomly determined according to a sequence index of the demodulation reference signal or the identification information of the transmitting device.

10. The information transmission apparatus according to claim 9, wherein the resources for transmitting the retransmission data are determined according to the number of retransmission resources and a demodulation reference signal correlation value, the demodulation reference signal correlation value changing along with the change of the number of times of transmission, and its initial value being the sequence index of the demodulation reference signal for initially transmitting the transmission information.

11. The information transmission apparatus according to claim 9, wherein the resources for transmitting the retransmission data are determined according to the number of the retransmission resources and a user equipment correlation value, the user equipment correlation value changing along with the change of the number of times of transmission, and its initial value being the identification information of the transmitting device.

12. The information transmission apparatus according to claim 1, wherein the control information containing acknowledgment or non-acknowledgment is carried in a physical downlink control channel;
and the processor is configured to scramble check information of the physical downlink control channel by using the identification information of the transmitting device or a sequence index of the demodulation reference signal of the transmission information.

13. The information transmission apparatus according to claim 1, wherein the control information containing acknowledgment or non-acknowledgment is carried in a physical hybrid automatic retransmission request indicator channel;
and the processor is configured to determine a logic resource position of the physical hybrid automatic retransmission request indicator channel by using a sequence index of the demodulation reference signal or the identification information of the transmitting device.

14. An information transmission apparatus, configured in a transmitting device, the information transmission apparatus comprising:
a memory that stores a plurality of instructions; and
a processor coupled to the memory and configured to execute the instructions to:
transmit transmission information containing data in a grant-free manner to a receiving device; wherein identification information of the transmitting device is explicitly or implicitly carried in the transmission information; and
receive control information containing acknowledgment or non-acknowledgment fed back by the receiving device, by using the identification information of the transmitting device or using sequence information of a demodulation reference signal that is used for demodulating the transmission information.

15. The information transmission apparatus according to claim 14, wherein the transmission information comprises the data, the identification information of the transmitting device and a check code generated according to the data and the identification information;
or, the transmission information comprises the data, a first check code generated according to the data, the identification information of the transmitting device and a second check code generated according to the identification information;
or, the transmission information comprises the data and a check code generated according to the data; wherein the check code is scrambled according to the identification information of the transmitting device;
or, the transmission information comprises the data and a check code generated according to the data; wherein a correspondence between the demodulation reference signal and the identification information of the transmitting device is predetermined.

16. The information transmission apparatus according to claim 14, wherein a range of the demodulation reference signal is pre-configured, and a sequence index of the demodulation reference signal is pseudo-randomly determined according to the identification information of the transmitting device.

17. The information transmission apparatus according to claim 16, wherein the demodulation reference signal of the transmission information is determined according to the number of sequences of the demodulation reference signal and a user equipment correlation value, the user equipment correlation value changing along with a change of the number of times of transmission, and its initial value being the identification information of the transmitting device.

18. The information transmission apparatus according to claim 14, wherein the processor is further configured to retransmit a designated redundancy version when the control information containing non-acknowledgment is received, and transmit data identical to that transmitted last time to the receiving device when neither the control information containing acknowledgment nor the control information containing non-acknowledgment is received;
wherein one or more resources for transmitting retransmission data is/are pseudo-randomly determined according to a sequence index of the demodulation reference signal or the identification information of the transmitting device.

19. The information transmission apparatus according to claim 18, wherein the resources for transmitting the retransmission data are determined according to the number of retransmission resources and a demodulation reference signal correlation value, the demodulation reference signal correlation value changing along with the change of the number of times of transmission, and its initial value being the sequence index of the demodulation reference signal for initially transmitting the transmission information;
or the resources for transmitting the retransmission data are determined according to the number of retransmission resources and a user equipment correlation value, the user equipment correlation value changing along with a change of the number of times of transmission, and its initial value being the identification information of the transmitting device.

20. A communication system, comprising:
a transmitting device configured to transmit transmission information containing data in a grant-free manner; wherein identification information of the transmitting device is explicitly or implicitly carried in the transmission information; and receive control information containing acknowledgment or non-acknowledgment; and
a receiving device configured to receive the transmission information containing data; demodulate and check the transmission information, and determine whether the identification information of the transmitting device and the data contained in the transmission information are correctly obtained; and feed the control information containing acknowledgment or non-acknowledgment back to the transmitting device, by using the identification information of the transmitting device, or using sequence information of a demodulation reference signal that is used for demodulating the transmission information.
